(19) United States
(12) Patent Application Publication
(10) Pub. No.: US 2021/0273391 A1
(43) Pub. Date: Sep. 2, 2021

(54) LIGHT FIXTURE CONNECTOR ASSEMBLIES

(71) Applicant: FLEX LTD, Singapore (SG)

(72) Inventors: Jonathan Daniels, The Colony, TX (US); Ted E. Samuelson, Flower Mound, TX (US); Jordon Musser, Dallas, TX (US)

(21) Appl. No.: 16/806,547

(22) Filed: Mar. 2, 2020

(51) Int. Cl. H01R 33/92; H01R 12/73; H01R 43/26; F21V 23/00; F21V 23/06; F21V 17/12

(52) U.S. Cl. CPC H01R 33/92; H01R 12/737; H01R 43/26; F21Y 2115/10; F21V 23/06; F21V 17/12; F21V 23/005

(57) ABSTRACT

Light fixture assemblies include a connector circuit board, light emitting diode (LED) printed circuit boards (PCBs), and an LED driver circuit. The connector board includes first LED PCB connectors and a first LED driver connector. The LED PCBs include second LED PCB connectors configured to connect to the first LED PCB connectors. The LED driver circuit includes a second LED driver connector configured to connect to the first LED driver connector. The first LED PCB connectors may include two or more first LED PCB connectors. Methods of assembling light fixtures include placing LED circuit boards including LED circuit board connectors on support structures, respectively, connecting connectors of a connector circuit board to the LED circuit board connectors, respectively, placing an end housing over the connector circuit board, and affixing the end housing to the support structures.

### FIELD

The present disclosure relates to light fixtures, and more particularly, to LED fixtures utilizing connector assemblies.

### BACKGROUND

Light emitting diode (LED)-based solid-state lighting (SSL) is now a commonly used technology, replacing incandescent, halogen, and compact fluorescent lights in commercial, industrial, and residential use. LED light sources provide many advantages over incandescent and fluorescent light sources, including: lower energy consumption, longer lifetime, improved robustness, smaller size, faster switching, and excellent durability and reliability. LEDs emit more light per watt than incandescent light bulbs. LEDs can be small and easily placed on printed circuit boards. LEDs activate and turn on very quickly and can be readily dimmed. LEDs emit a cool light with very little infrared light. The operational life of some LED lamps is 100,000 hours, which is much longer than the average life of an incandescent bulb or fluorescent lamp.

Another important advantage of LED lighting is reduced power consumption. An LED circuit can approach 80% efficiency, which means 80% of the electrical energy is converted to light energy. The remaining 20% of the electrical energy is lost as heat energy. In contrast, incandescent bulbs operate at about 20% efficiency with 80% of the electrical energy lost as heat.

Linear LED lamps typically include an array of LEDs mounted on one or more circuit boards. Common lamp formats approximate the overall appearance and dimensions of their fluorescent counterparts. The LED boards are mounted on an elongate heat sink including a heat conducting material such as aluminum. The LED circuit boards are in thermal contact with the heat sink, but are electrically isolated from the heat sink. The LED circuit board may include driver circuitry for converting AC line current to DC current and for reducing and controlling the voltage applied to the LEDs.

In the manufacturing process, the LED circuit boards are connected with the electrical wiring in the LED fixture housing, which, in turn, connects to the power supply and driver circuitry. Typically, the manufacturing process involves steps of soldering conductive components on the end connectors and the LED printed circuit boards. Wires are commonly used in these designs with the ends of the wires soldered during the assembly process. If the conductive components are not properly connected, the lighting fixture may be inoperable. Soldered connections are also prone to failing when subjected to forces in use. Generally, it may be difficult to maintain a high level of quality control, regardless of the care taken in assembling these types of components. Aside from the quality issue, the assembly steps that involve the electrical connection of the conductors are inherently time consuming and may require relatively skilled labor and/or expensive automated systems.

Disassembly of such lamps presents similar difficulties and expense. As a result of these difficulties associated with assembly and disassembly, refurbishing such lamps to replace defective or worn out components is difficult to justify economically. In most cases, the entire lamp assembly will simply be discarded and replaced with a new lamp assembly, and as a result, lamp components that have significant useful life remaining are wasted.

### SUMMARY

One general aspect of the disclosure features a light fixture including a connector board. The connector board may include first LED printed circuit board (PCB) connectors and a first LED driver connector. The light fixture also includes LED PCBs including second LED PCB connectors, e.g., connection pads, connected to the first LED PCB connectors. The light fixture also includes an LED driver circuit including a second LED driver connector, e.g., a wire lead, connected to the first LED driver connector.

Implementations may include one or more of the following features. The first LED PCB connectors may include two, four, six, or more LED PCB connectors. The first LED PCB connectors may be male connectors and the second LED PCB connectors may be female connectors. Alternatively, the first LED PCB connectors may be female connectors and the second LED PCB connectors may be male connectors. The light fixture may include a housing configured to receive and enclose the connector board. The connector board may include electrically-conductive traces electrically coupling the first LED PCB connectors to the first LED driver connector. The first LED PCB connectors may be female slot connectors including slots, which are perpendicular to a plane of the connector board. Each of the LED PCBs may include second LED PCB connectors. The connector assembly board may include first LED printed circuit board (PCB) connectors and a first LED driver connector, and the light fixture may include an LED driver circuit including a second LED driver connector or a set of second LED driver connectors.

Another general aspect of the disclosure features a connector circuit board assembly, which also includes a circuit board. The connector circuit board assembly also includes LED printed circuit board (PCB) connectors coupled to the circuit board on opposite sides of the circuit board. The connector circuit board assembly also includes a plurality of LED driver connectors coupled to the circuit board between the LED PCB connectors.

Implementations may include one or more of the following features. The LED driver connectors may be pressure-fit male connectors configured to receive and couple to an end portion of a wire. The LED PCB connectors may include at least two LED PCB connectors electrically coupled together in series by electrically-conductive traces of the circuit board. A first LED driver connector of the LED driver connectors may be electrically coupled to a first end portion of the series-connected LED PCB connectors by a first electrically-conductive trace of the circuit board, and a second LED driver connector of the LED driver connectors may be electrically coupled to a second end portion of the series-connected LED PCB connectors by a second electrically-conductive trace of the circuit board. The LED PCB connectors may include two LED PCB connectors on a first side of the circuit board and two LED PCB connectors on a second side of the circuit board. The LED PCB connectors of the first and second sides of the circuit board may be coupled together in series. A first LED driver connector of the LED driver connectors may be electrically coupled to a first end portion of the series-connected LED PCB connectors by a first electrically-conductive trace of the circuit board. A second LED driver connector of the LED driver connectors may be electrically coupled to a second end portion of the series-connected LED PCB connectors by a second electrically-conductive trace of the circuit board.

Still another general aspect of the disclosure features a method of assembling an LED light fixture. The method of assembling includes placing LED circuit boards including LED circuit board connectors on support structures, respectively. The method of assembling also includes connecting connector circuit board connectors to the LED circuit board connectors, respectively. The method of assembling also includes placing an end housing over the connector circuit board. The method of assembling also includes affixing the end housing to the support structures.

Implementations may include one or more of the following features. Connecting the LED circuit board connectors to the connector circuit board connectors may include inserting the LED circuit board connectors into the connector circuit board connectors, respectively. Affixing the end housing to the support structures may include passing fasteners through apertures in the end housing corresponding to the support structures and affixing end portions of the fasteners to the support structures, respectively. The fasteners may be screws. Placing an end housing over the connector circuit board may include seating the connector circuit board in the end housing.

### BRIEF DESCRIPTION OF THE DRAWINGS

Various aspects and features of the present disclosure are described hereinbelow with reference to the drawings, wherein:

FIGS. 1A-1C are perspective, exploded views of an end portion of a light fixture assembly according to aspects of this disclosure;

FIGS. 2A and 2B are perspective views of the bottom side of a portion of the light fixture assembly of FIGS. 1A-1C;

FIG. 2C is a perspective view of the bottom side of a portion of the light fixture assembly of FIGS. 2A and 2B in a different orientation;

FIG. 3A is a schematic circuit diagram of a light fixture connector assembly configured to connect with six light-emitting diode (LED) circuit boards according to still other aspects of this disclosure;

FIG. 3B is a schematic circuit diagram of a light fixture connector assembly configured to connect with four light-emitting diode (LED) circuit boards according to other aspects of this disclosure;

FIG. 3C is a schematic circuit diagram of a light fixture connector assembly configured to connect with two light-emitting diode (LED) circuit boards according to some aspects of this disclosure; and

FIG. 4 is a flow diagram of a method of assembling a light fixture according to one aspect of the disclosure.

### DETAILED DESCRIPTION

This disclosure is directed to light fixture assemblies that include a connector board, light emitting diode (LED) printed circuit boards (PCBs), and an LED driver circuit. The connector board allows for easier and quicker assembly of an LED light fixture. The connector board includes first LED PCB connectors, e.g., first LED connection pads, and a first LED driver connector, e.g., a first wire lead. The LED PCBs include second LED PCB connectors, e.g., second LED connection pads, connected to the first LED PCB connectors. The LED driver circuit includes a second LED driver connector, e.g., a second wire lead, connected to the first LED driver connector. The first LED PCB connectors may include two, four, six, or more LED PCB connectors. The first LED PCB connectors may be male connectors and the second LED PCB connectors may be female connectors or vice versa. The disclosure is also directed to methods of assembling light fixtures. A method includes placing LED circuit boards including first connectors on support structures, respectively, connecting second connectors of a connector circuit board to the first connectors, respectively, placing an end housing over the connector circuit board, and affixing the end housing to the support structures.

The printed circuit boards may include, for example, a conventional printed circuit board, a specialized printed circuit board (e.g., a flexible printed circuit board), single-sided, double-sided, multilayer or any other appropriate type of wiring board, all of which are generically referred to herein as a “printed circuit board” or “PCB”. “Light emitting diode” and “LED” in the context of this disclosure may refer to all types of light emitting diodes used for lighting applications including semiconductor light-emitting diodes (LEDs), organic light emitting diodes (OLEDs), and polymer light-emitting diodes (PLEDs).

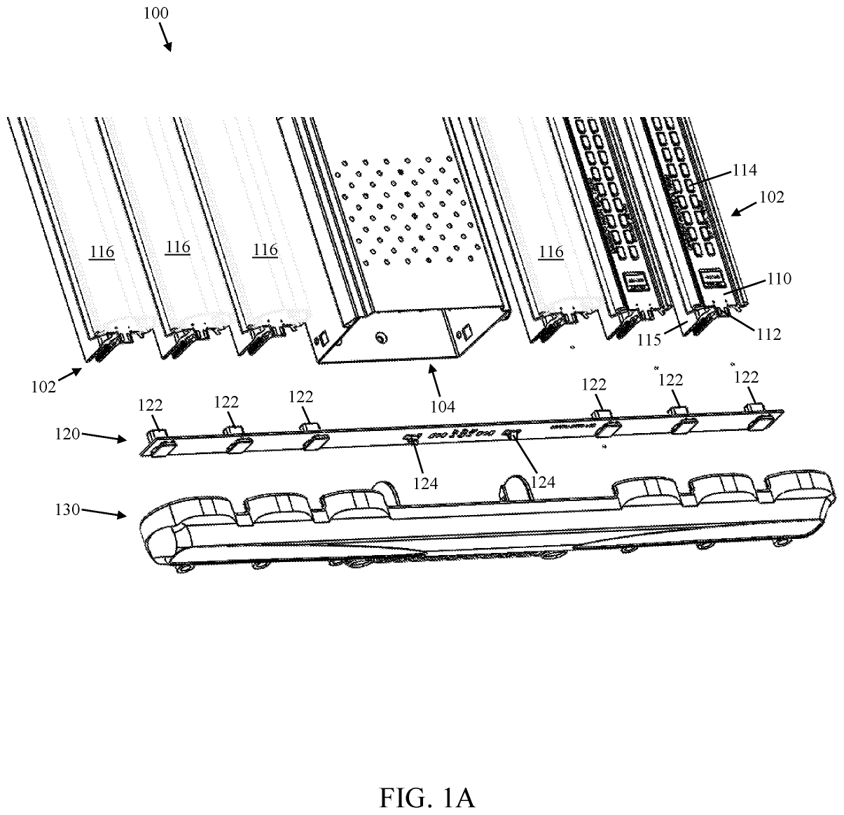

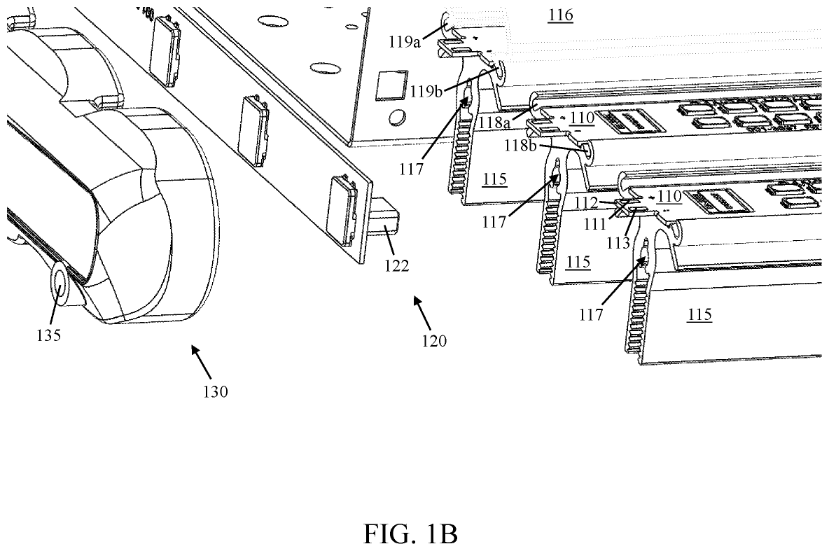

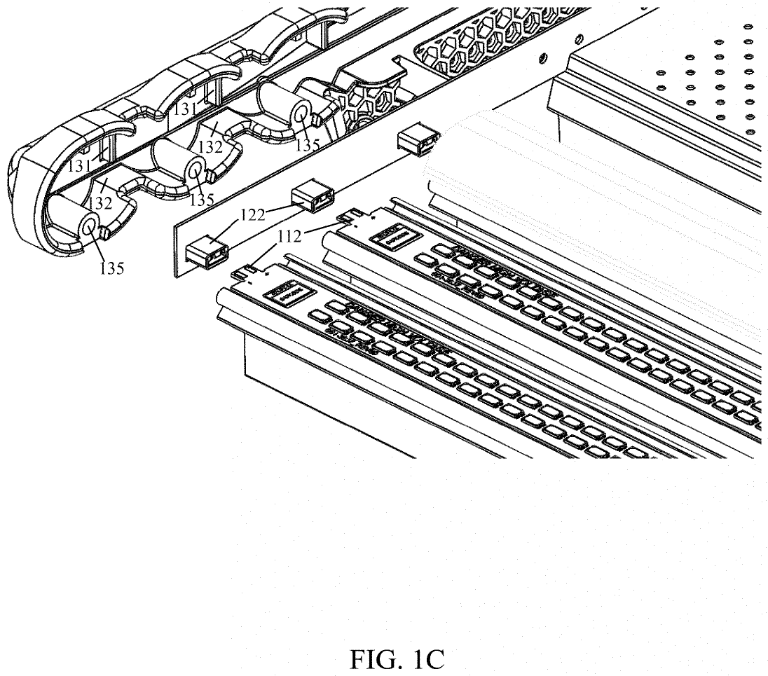

FIGS. 1A-1C illustrate an end portion of a light fixture assembly 100 according to aspects of this disclosure. As shown in FIG. 1A, the light fixture assembly includes six light assemblies 102. In aspects, the light fixture assembly 100 may include more or less than six light assemblies 102. For example, the light fixture assembly 100 may include two or four light assemblies 102. In aspects, the light fixture assembly 100 may include one or more pairs of light assemblies 102.

Each of the light assemblies 102 includes an LED circuit board 110 that includes multiple LEDs 114 and a first connector 112. The first connector 112 includes a positive terminal 111 and a negative terminal 113 exposed on one side of the first connector 112. In aspects, the first connector 112 may only include a positive terminal or electrode and a negative terminal or electrode that protrude from the LED circuit board 110 and electrically couple to the LEDs 114 via electrically-conductive traces (not shown). Each of the light assemblies 102 also includes a support structure 115 configured to receive and support the LED circuit board 110. Each of the light assemblies 102 also includes a lens 116, which, for example, may connect to the support structure 115 via a tongue and groove connection where tongues 119a, 119b on opposite sides of the lens 116 mate with corresponding grooves 119a, 119b in the support structure 115. The lens 116 may be configured to diffuse, disperse, or refract the light emitted from the LEDs 114 in a desired manner. For example, the lens 116 may be configured to modify the light emitted from the LEDs 114 so that the light passing out of the lens 116 is a soft light.

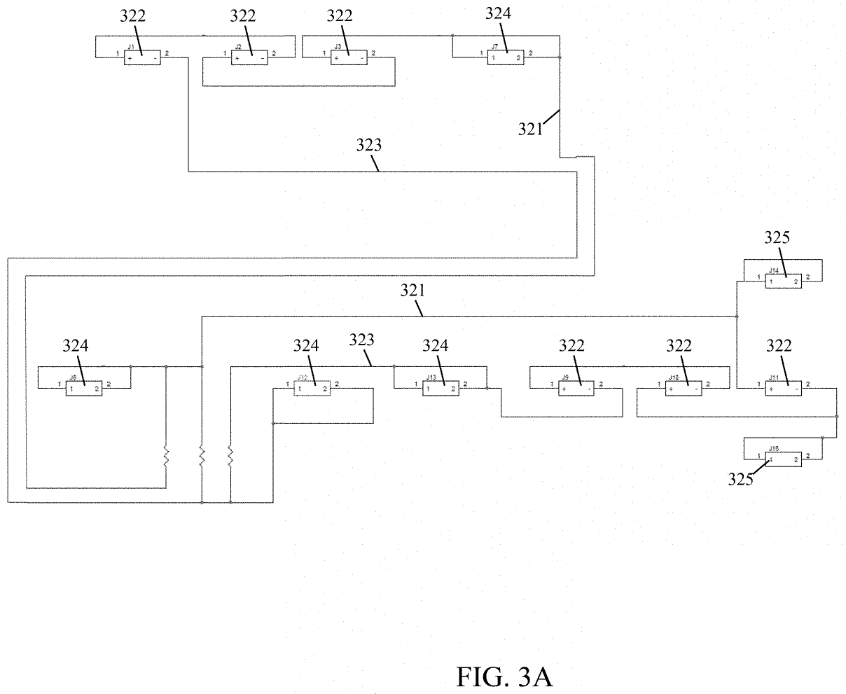

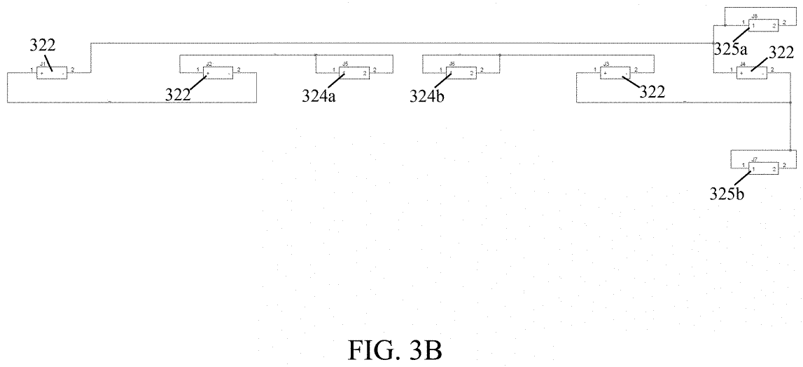

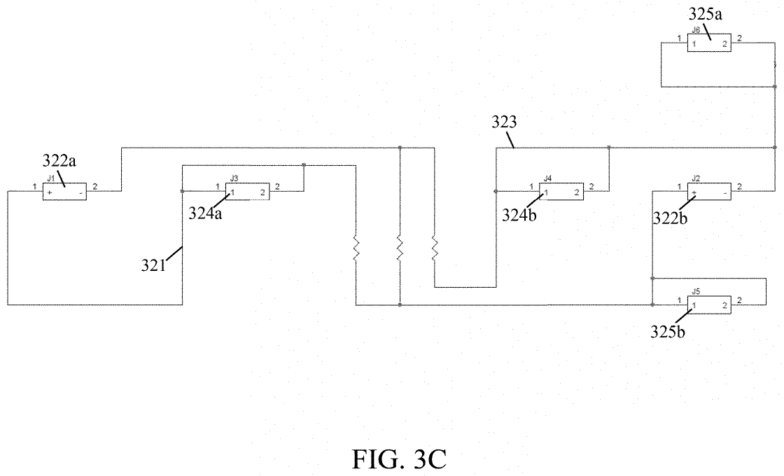

The light fixture assembly 100 also includes a connector circuit board 120 that includes multiple second connectors 122. During manufacturing, the second connectors 122 may be interference- or pressure-fitted into suitably-sized apertures formed in a printed circuit board (PCB). When the second connectors 122 are fitted into the apertures, the second connectors 122 electrically connect to electrically-conductive traces, e.g., metal traces, of the PCB. In some aspects, the second connectors 122 may be soldered to the electrically-conductive traces. The electrically-conductive traces may be arranged, for example, according to the wiring shown in the circuit diagrams of FIG. 3A, 3B, or 3C. The second connectors 122 are configured to mate with and electrically connect to the positive terminals 111 and the negative terminals 113 of the first connectors 112 of the light assemblies 102. In aspects, the first connectors 112 may be male or female connectors and the second connectors 122 may be female or male connectors, respectively. In aspects, the first and second connectors 112, 122 may be slot connectors or pin connectors.

The light fixture assembly 100 also includes an LED power supply housing 104 for housing one or more power supplies (not shown) for supplying power to the LED circuit boards 110 via the connector circuit board 120. The one or more LED power supplies may be connected to the power supply connectors 124 via wires that are soldered to the power supply connectors 124 or via any other suitable structure and/or method of electrically connecting the LED power supply housing 104 to the power supply connectors 124.

The light fixture assembly 100 also includes an end housing 130. The end housing 130 includes standoffs 131 that protrude from the inside surface of the end housing 130, bottom seats 132, and top seats (not shown) opposite from the bottom seats 132 for holding the connector circuit board 120 in place when the light fixture assembly 100 is assembled. The end housing 130 also includes holes 135 configured to receive screws or other fasteners suitable for connecting the end housing 130 to the light assemblies 102. After passing through the holes 135, the screws are configured to be fixed within counter holes 117, respectively, of the support structure 115 of each light assembly 102 in order to secure the end housing 130 to the light assemblies 102. The light fixture assembly 100 may include a second end housing (not shown) similar to the end housing 130, which is secured to the other ends of the light assemblies 102.

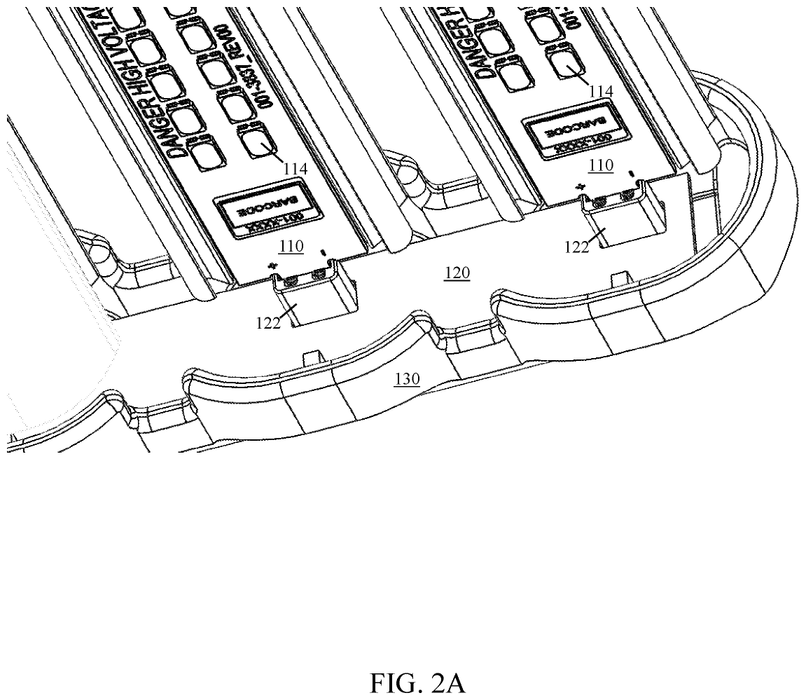

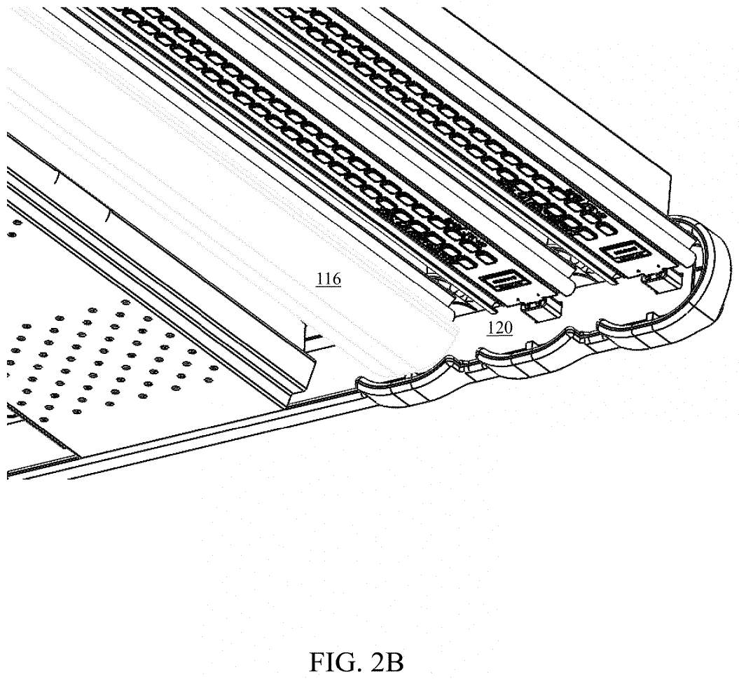

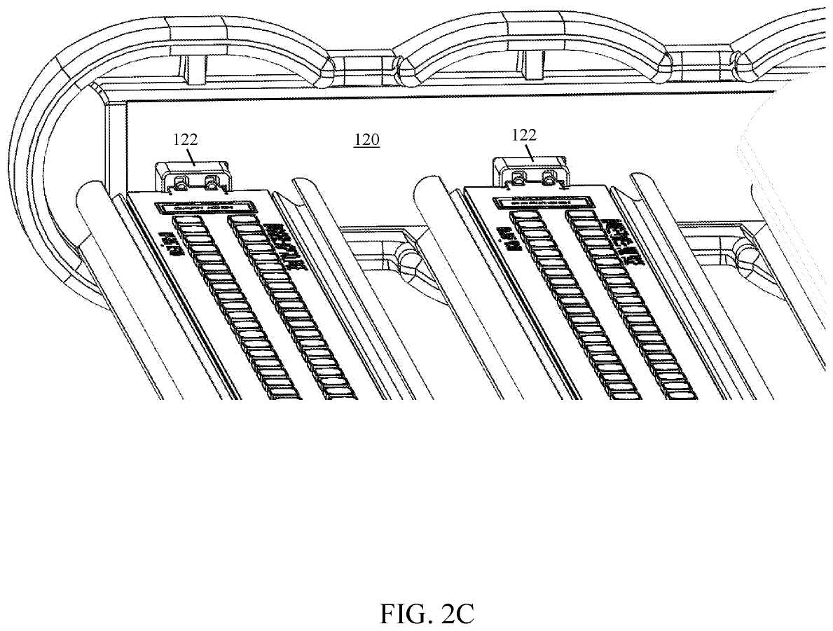

FIGS. 2A-2C illustrate perspective views of the bottom side of a portion of the light fixture assembly of FIGS. 1A-1C in an assembled state. The connector circuit board 120 is seated on the inside of the end housing 130 and the female slot connectors of the first connectors 112 are matingly engaged with the male slot connectors of the second connectors 122, respectively. The LED circuit boards 110 are configured such that, when the positive and negative terminals of the first connectors 112 are connected to the respective positive and negative terminals of the second connectors 122, the LEDs 114 face downward to emit light down into a room or other space.

FIG. 3A is a schematic circuit diagram of a connector circuit board, e.g., the connector circuit board 120 of FIGS. 1A-1C, configured to connect with six light-emitting diode (LED) circuit boards, e.g., the LED circuit boards 110 of FIGS. 1A-1C, according to some aspects of this disclosure. The connector circuit board includes six or more LED circuit board connectors 322 and six backup power connectors 324. Groups of three LED circuit board connectors 322 are connected in series. The ends of the series-connected LED circuit board connectors 322 are connected to positive and negative terminals of the connector circuit board.

FIG. 3B is a schematic circuit diagram of a connector circuit board configured to connect with four LED circuit boards according to other aspects of this disclosure. The connector circuit board includes four LED circuit board connectors 322 connected together in series between a positive power supply connector 324a and a negative power supply connector 324b. In other words, the four LED circuit board connectors 322 are connected together such that a negative terminal of one LED circuit board connector 322 is connected to a positive terminal of another LED circuit board connector 322. The connector circuit board also includes a positive backup power supply connector 325a connected to and a negative backup power supply connector 325b. The LED circuit board connectors 322 and the power supply connectors 324a, 324b, 325a, 325b may be connected together in the arrangement shown in FIG. 3B and described above using electrically-conductive traces formed in the connector circuit board.

FIG. 3C is a schematic circuit diagram of a connector circuit board configured to connect with two light-emitting diode (LED) circuit boards according to still other aspects of this disclosure. The connector circuit board includes two LED circuit board connectors 322a, 322b. A positive terminal of the LED circuit board connector 322a is connected to a positive power supply connector 324a via electrically-conductive trace 321 and a negative terminal of the LED circuit board connector 322a is connected to a negative power supply connector 324b via resistor R3. A positive terminal of the LED circuit board connector 322b is connected to the positive power supply connector 324a via resistor R1 and a negative terminal of the LED circuit board connector 322a is connected to the negative power supply connector 324b via electrically-conductive trace 323.

The connector circuit board of FIG. 3C also includes a positive backup power supply connector 325a connected to the positive terminal of LED circuit board connector 322b and a negative backup power supply connector 325b connected to the negative terminal of LED circuit board connector 322b. The LED circuit board connectors 322a, 322b and the power supply connectors 324a, 324b, 325a, 325b may be connected together in the arrangement shown in FIG. 3C and described above using electrically-conductive traces formed in the connector circuit board.

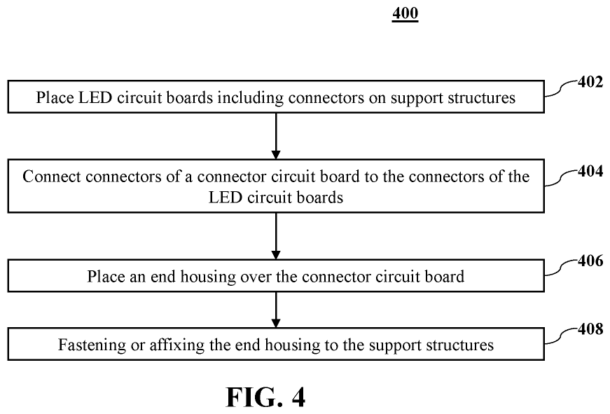

FIG. 4 is a flow diagram of a method of assembling a light fixture 400 according to one aspect of the disclosure. At block 402, LED circuit boards including connectors are placed on respective support structures. Each LED circuit board may be placed in a recess formed in each corresponding support structure. At block 404, connectors of a connector circuit board are connected to respective connectors of the LED circuit board. Connecting the connectors of the LED circuit board to the connectors of the connector circuit board may include inserting the connectors of the LED circuit board, which may include male slot or pin connectors, into the connectors of the connector circuit board, which may include female slot or pin connectors.

At block 406, an end housing is placed over the connector circuit board. Placing an end housing over the connector circuit board may include seating the connector circuit board in the end housing. Then, at block 408, the end housing is affixed or fastened to the support structures. Fastening the end housing to the support structures may include passing screws through apertures in the end housing and fastening end portions of the screws to corresponding support structures. In some aspects, that end housing is affixed to the support structures using an adhesive, such as glue.

While several aspects of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular aspects.

What is claimed is:

1. A light fixture comprising:
a connector circuit board comprising:
a plurality of first LED printed circuit board (PCB) connectors; and
a first LED driver connector;
a plurality of LED PCBs including a plurality of second LED PCB connectors connected to the plurality of first LED PCB connectors; and
an LED driver circuit including a second LED driver connector connected to the first LED driver connector.

2. The light fixture of claim 1, wherein the plurality of first LED PCB connectors includes two, four, six, or more first LED PCB connectors, and
wherein the plurality of second LED PCB connectors includes two, four, six, or more second LED PCB connectors.

3. The light fixture of claim 1, wherein the plurality of first LED PCB connectors are male connectors and the plurality of second LED PCB connectors are female connectors.

4. The light fixture of claim 1, wherein the plurality of first LED PCB connectors are female connectors and the plurality of second LED PCB connectors are male connectors.

5. The light fixture of claim 1, further comprising a housing configured to receive and enclose the connector board.

6. The light fixture of claim 1, wherein the connector circuit board includes electrically-conductive traces electrically coupling the plurality of first LED PCB connectors to the first LED driver connector.

7. The light fixture of claim 1, wherein the plurality of first LED PCB connectors is a plurality of female slot connectors, which are perpendicular to a plane of the connector board, and
wherein the plurality of second LED PCB connectors is a plurality of male slot connectors.

8. The light fixture of claim 1, wherein the plurality of first LED PCB connectors is a plurality of female pin connectors, and
wherein the plurality of second LED PCB connectors is a plurality of male pin connectors.

9. A connector circuit board assembly comprising:
a circuit board;
a plurality of LED printed circuit board (PCB) connectors coupled to the circuit board on opposite sides of the circuit board; and
a plurality of LED driver connectors coupled to the circuit board between the LED PCB connectors.

10. The connector circuit board assembly of claim 9, wherein the plurality of LED driver connectors are pressure-fit male connectors configured to receive and couple to an end portion of a wire.

11. The connector circuit board assembly of claim 9, wherein the plurality of LED PCB connectors includes at least two LED PCB connectors electrically coupled together in series by a plurality of electrically-conductive traces of the circuit board,
wherein a first LED driver connector of the plurality of LED driver connectors is electrically coupled to a first end portion of the series-connected LED PCB connectors by a first electrically-conductive trace of the circuit board, and
wherein a second LED driver connector of the plurality of LED driver connectors is electrically coupled to a second end portion of the series-connected LED PCB connectors by a second electrically-conductive trace of the circuit board.

12. The connector circuit board assembly of claim 9, wherein the plurality of LED PCB connectors includes two LED PCB connectors on a first side of the circuit board and two LED PCB connectors on a second side of the circuit board,
wherein the LED PCB connectors of the first and second sides of the circuit board are coupled together in series,
wherein a first LED driver connector of the plurality of LED driver connectors is electrically coupled to a first end portion of the series-connected LED PCB connectors by a first electrically-conductive trace of the circuit board, and
wherein a second LED driver connector of the plurality of LED driver connectors is electrically coupled to a second end portion of the series-connected LED PCB connectors by a second electrically-conductive trace of the circuit board.

13. A method of assembling an LED light fixture, comprising:
placing a plurality of LED circuit boards including a plurality of LED circuit board connectors on a plurality of support structures, respectively;
connecting a plurality of connector circuit board connectors of a connector circuit board to the plurality of LED circuit board connectors, respectively;
placing an end housing over the connector circuit board; and
affixing the end housing to the plurality of support structures.

14. The method of claim 13, wherein connecting the plurality of LED circuit board connectors to the plurality of connector circuit board connectors includes inserting the plurality of LED circuit board connectors into the plurality of connector circuit board connectors, respectively.

15. The method of claim 13, wherein affixing the end housing to the plurality of support structures includes:
passing a plurality of fasteners through a plurality of apertures in the end housing corresponding to the plurality of support structures; and
affixing end portions of the plurality of fasteners to the plurality of support structures, respectively.

16. The method of claim 15, wherein the plurality of fasteners is a plurality of screws.

17. The method of claim 13, wherein placing an end housing over the connector circuit board includes seating the connector circuit board in the end housing.

18. The method of claim 13, wherein the plurality of LED circuit board connectors is a plurality of connection pads.
